(19) United States
(12) Patent Application Publication
(10) Pub. No.: US 2017/0193495 A1
(43) Pub. Date: Jul. 6, 2017

(54) GIFT CARD PROGRAM MANAGEMENT PLATFORM

(71) Applicants: Ulderico Conte, Henderson, NV (US); Terry A. Cartwright, Henderson, NV (US); Robert S. Chang, Diamond Bar, CA (US)

(72) Inventors: Ulderico Conte, Henderson, NV (US); Terry A. Cartwright, Henderson, NV (US); Robert S. Chang, Diamond Bar, CA (US)

(21) Appl. No.: 14/989,593

(22) Filed: Jan. 6, 2016

(51) Int. Cl. G06Q 20/34

(52) U.S. Cl. CPC G06Q 20/3433

(57) ABSTRACT

The present invention provides an integrated web-based platform for merchants to create, process and manage gift card programs. Merchants can utilize the web-based platform to securely define and modify gift card program parameters, such as program dates, card denominations, discount percentages, and investment amounts. Merchants can subsequently monitor the status and performance of their gift card programs. The platform provides methods for presenting and processing consumer gift card transactions and payment of transaction commissions between merchants and the platform provider.

### RELATED U.S. APPLICATION DATA

This application claims priority to Provisional Application No. 62/100,803, filed Jan. 7, 2015.

### FIELD OF THE INVENTION

The disclosure relates to the creation and management of web-based gift card programs.

### BACKGROUND OF THE INVENTION

Gift cards are a widely used product offered by a large number of merchants and retailers to be used in connection with their goods and services. With the advancement of ecommerce, web-based platforms can be utilized to market and sell gift cards. However, there are currently no universal web-based tools for merchants and consumers to effectively create, promote and manage their gift card programs. Studies show that over 12% of traditional gift cards purchased remain lost or unused, which makes electronic gift cards more advantageous. It is desirable to have more effective web-based systems and methods for creating, marketing, selling and managing gift card programs, including methods for franchises and merchants to allocate marketing budgets to gift card programs. It is also desirable to have a web-based gift card platform that provides cyber security independent of merchants' payment card industry (PCI) compliance and makes hacking of merchant point of sale systems obsolete.

### SUMMARY

The present invention provides an integrated web-based platform for merchants to create, process and manage gift card programs. Merchants can utilize the web-based platform to securely define and modify gift card program parameters, such as program dates, card denominations, discount percentages, and investment amounts. Merchants can subsequently monitor the status and performance of their gift card programs. The platform provides methods for presenting and processing consumer gift card transactions and payment of transaction commissions between merchants and the platform provider.

A related aspect provides for control of marketing spend related to gift cards and processes and systems for ensuring that marketing dollars spent on gift card programs achieve direct benefits related to sales of products and services.

Another aspect provides for processing gift card transactions and for facilitating commission payments for each transaction between franchisors (those merchants, purchasing a gift card program) and franchisees (establishments that agree to accept a given merchant's gift cards).

Yet another aspect provides for the aggregation of gift cards in a single online location with the capability for quick and easy navigation by consumers to gift cards associated with a desired merchant, product, service, discount, amount or other desired attribute.

Yet another aspect of the invention provides for an e-card wallet associated with a given consumer that may be stored on a user's mobile device or stored virtually and quickly retrieved as well as used in place of, or as a back up to physical gift cards.

Yet another aspect provides a secure single-use transaction that may be used for purchasing goods and services in conjunction with the gift card programs disclosed herein, or otherwise independent of a gift card program.

### BRIEF DESCRIPTION OF THE DRAWINGS

The above and other attendant advantages and features of the invention will be apparent from the following detailed description together with the accompanying drawings, in which like reference numerals represent like elements throughout. It will be understood that the description and embodiments are intended as illustrative examples and are not intended to be limiting to the scope of invention, which is set forth in the claims appended hereto.

FIG. 1 illustrates an overall process for facilitating gift card programs in accordance with the present invention.

FIG. 2 illustrates a merchant login and gift card program initiation process in accordance with the present invention.

FIG. 3 illustrates a process for implementing live gift card offerings to consumers via a website in accordance with the present invention.

FIG. 4 illustrates a process supported by a customer user interface in accordance with the present invention.

FIG. 5 illustrates a single use transaction process in accordance with the present invention.

FIG. 6 illustrates a merchant reporting process in accordance with the present invention.

FIG. 7 illustrates a computing technology infrastructure in which the present invention can be implemented.

FIG. 8 illustrates an application architecture implementing the gift card platform of the present invention.

FIG. 9 illustrates a transactional overview and information flow diagram in accordance with the present invention.

### DETAILED DESCRIPTION

Servers hosting the service and executing applications on a computing platform as described herein may be associated with a domain name, such as EcardDeal.com, as a website on a wide area network (WAN). The website may serve as a gift card platform to the public, offering for sale cards from a large number of merchants, each of whom have entered into appropriate agreements with a service provider operating infrastructure according to the inventions disclosed herein. The general public may access the gift card platform via desktop or mobile applications running on mobile devices. Tools may be provided, such as search or filtering tools that list search result gift cards based on various criteria (e.g., percentage or amount of discount) to enable a user to quickly navigate and find an appropriate gift card among those listed in the search results. The gift card platform may organize the gift cards into relevant categories (e.g. “pet stores” or “clothing”) for users to click to see a listing of gift cards associated with a particular category.

Once purchased, a gift card may be stored in a virtual “wallet” associated with the user's account or profile on the website. In a mobile device environment, the gift cards purchased by a consumer may be stored on the mobile device in a virtual wallet. According to novel aspects of the system described herein, the credit, or prepaid gift card “dollars” are stored in accounts of each merchant and not by the provider hosting the gift card service. In this regard, the hosting provider acts as a matchmaker or an exchange that facilitates the purchase, storage and redemption of gift cards for every consumer and every merchant participating in the gift card campaigns or programs supported by the system.

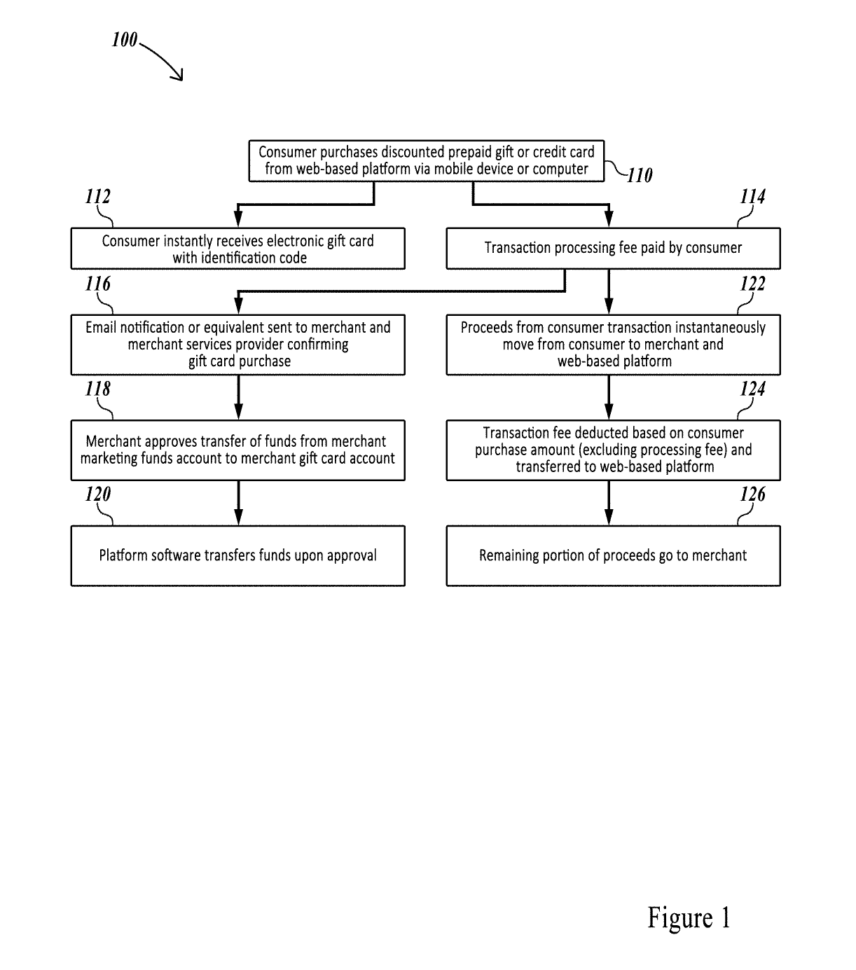

FIG. 1 illustrates an exemplary overview of a process for facilitating gift card programs in accordance with the present invention. At 110, a consumer may purchase discounted prepaid gift cards from a single .website (e.g. “eCardDeal.com” for purposes of illustration herein) using a mobile device or desktop computer. At 112, upon purchasing the gift card, the consumer instantly receives the card with a unique identification code. The card may be discounted as an incentive for purchase. For example, the gift card may provide for the purchase of $100 of merchandise at an $80 cost to the consumer. Delivery of the card may be by mail, if a physical card is desired, or by electronic transmission to the user's mobile device, where a representation of the card, and the unique identification code may be stored on the user's mobile device in a virtual “wallet” for later retrieval.

At 114, a processing fee is paid by the consumer, at the time of purchase, to a service provider facilitating the gift card purchase transaction. According to unique aspects of this disclosure, the processing fee is paid independent of the marketing fee process (described below) such that the service provider does not have direct involvement in the exchange of funds between the consumer and merchant, or between the merchant and franchisee (sales point where the gift card will be used). Rather, the exchange of funds between these entities occurs independent of the service provider, which essentially operates as a matchmaker or exchange that connects merchants, consumers and franchisees.

At 116, an electronic notification, such as an email or other data, is sent to the merchant associated with the gift card purchased by the consumer, which notifies the merchant that a discounted gift card has been purchased. At 118, the merchant approves the transfer of funds from the merchant's marketing account to the merchants gift card account. At 120, once the approval from the merchant is received by the host application (as discussed below) funds will be transferred from the merchant's marketing account to the merchant's gift card account.

At 122, the proceeds from the consumer gift card purchase transaction are transferred from the consumer to the merchant and to the service provider (e.g. “eCardDeal.com”). At 124, a transaction fee, which may be a small percentage of the transaction value or money spent by the consumer is transferred to the service provider. The transaction fee is comparable to the standard transaction fee charged by credit card companies to merchants, conventionally around 3%. For example if a consumer purchases a $100 gift card for $80, then the merchant will pay EcardDeal.com $2.40 or 3% of the $80 transaction amount paid by the consumer. The processing fee is the fee which the consumer pays to eCardDeal.com at the time of purchase. For example if the consumer buys a $100 gift card for $80, then the total charge to the consumer will be $80.39. The $0.39 is the processing fee which is directly paid to eCardDeal.com at time of sale. It should be noted that the aforementioned transaction fees are merely exemplary, and other transaction fee amounts can be utilized in accordance with the present invention.

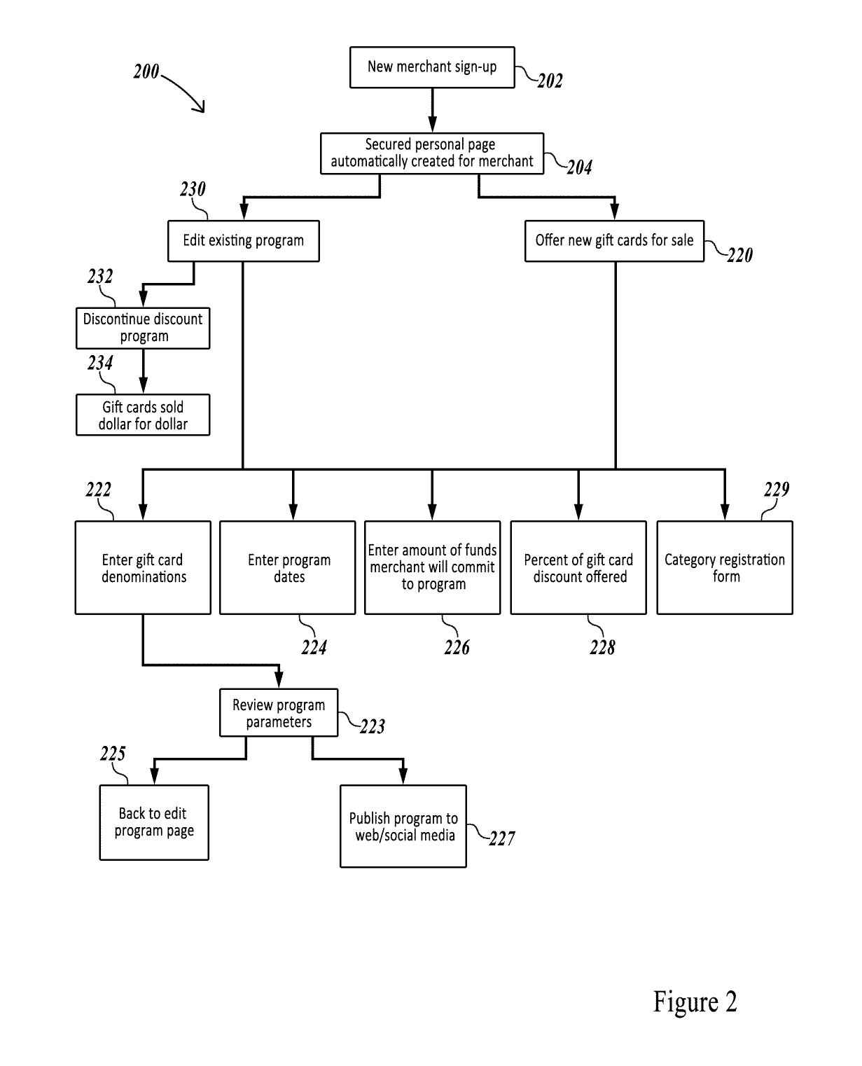

FIG. 2 illustrates an exemplary process for merchant login and initiating a gift card program or offering. At step 202, a merchant logs in, if a returning merchant, or creates a new merchant profile if using the system for the first time where a secure personal page may be created at 204. A decision is made by the merchant as to editing an existing program (step 230) or initiating a new gift card offering (step 220). If the merchant desires to edit an existing program, the option to discontinue the program is provided at step 232, and at step 234 the gift cards still issued under the program may be sold dollar for dollar. The Merchant has direct access to the eCardDeal.com network once they have signed up. The merchant may then “publish” their respective offers by accessing the eCardDeal.com deal publishing platform which includes the features described below.

Steps 222, 224, 226, 228 and 229 are performed for both the edit gift card program or the new gift card offering options. At step 222, the merchant inputs desired gift card denominations (e.g., $25, $50, $75, $100). At step 224 program dates may be specified that define the time period during which the gift cards will be available for purchase. At step 226, the amount of marketing funds that the merchant will commit to the program may be specified. At step 228, the percent of discount on the gift card may be input (e.g., a 20% discount resulting in $100 gift card available for purchase for $80). At step 229, a category registration form may be created by the merchant: A category registration may be used by a merchant to register their business much like the standard industrial classification (SIC) codes for the purpose of more easily attracting potential customers. For example, if a merchant is a hardware store chain they may choose to register their gift card deals under the “home improvement” category. At step 223, the merchant may review all details about the newly created or newly edited offering. If changes are desired at step 225, the process returns to the edit offering page. If the details meet with approval of the merchant, at step 227 the offering is published by the service provider on the gift card exchange platform.

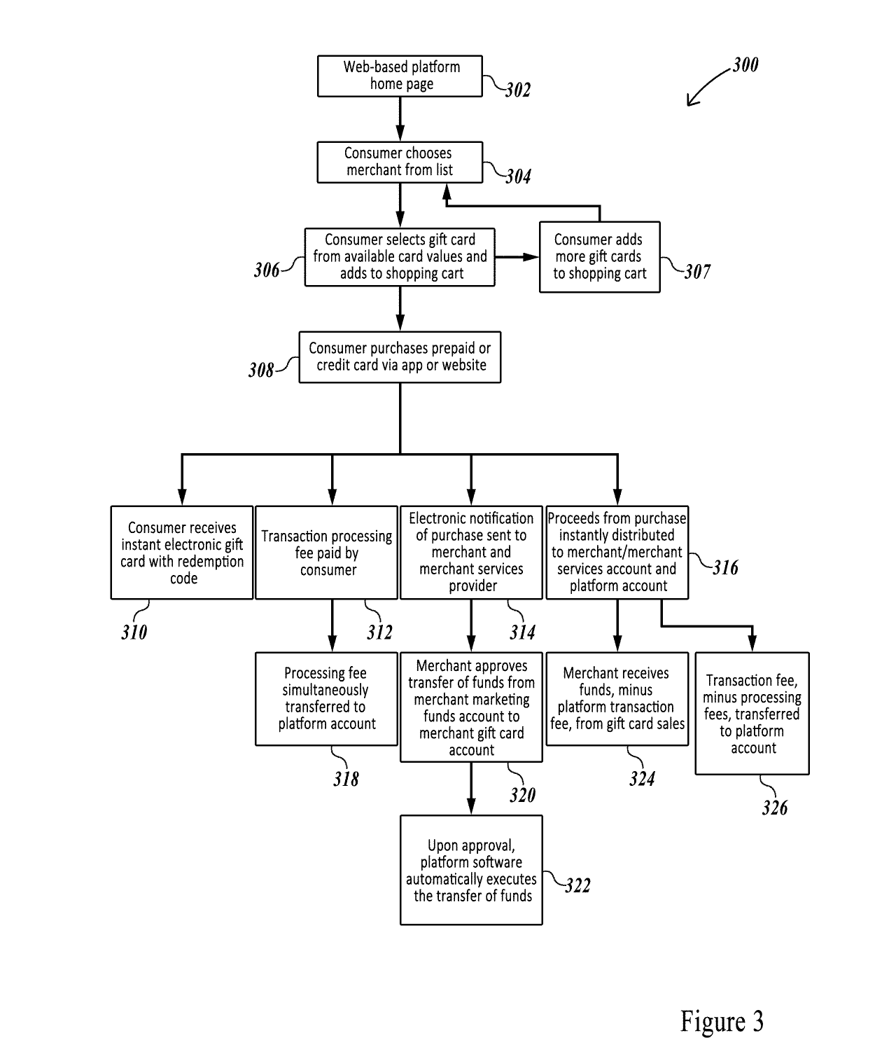

FIG. 3 illustrates a process 300 for providing live gift card offerings to consumers. Step 302 represents a home page of a website with which the service is associated. At this step, a “front page” may be displayed to the user with offers for gift cards that are searchable. An option to “view all offers” may be displayed, at which point the process leads to step 304. At step 304, the consumer may choose a specific merchant from a list, such as a drop-down menu, displayed on the website. Alternatively, the consumer could use a search filter on the website and specify one or more attributes of desired gift cards. Such filters or controls may be provided to list “consumer preferences” based on a consumer profile or historical purchases, or a “best deals” option may present the best deals for a day or given time period, or a “favorite companies” or “favorite industries” option may be presented. At step 306, the consumer selects a card from a number of displayed cards meeting the desired criteria. For example, a table of card values for a specific merchant may be displayed with the card value in one column and the discounted purchase value (e.g., labeled “You Pay”) listed in an adjacent column. After a consumer chooses a card, the process proceeds. If additional cards are desired, at step 307 the consumer may add more cards to a virtual shopping cart on the website interface. This may be in response to a prompt. At step 308 the consumer purchases the prepaid gift card using a credit card or electronic funds transfer, and a “check out” option may be presented to enable the user to complete the online purchase transaction.

At step 310, the gift card (virtual) may be received instantly and may include a redemption code to permit the user to redeem the card at a later time. This may be done via email or texting of a code or otherwise communicating a unique code associated with the gift card to the consumer. At step 312, the consumer may agree (electronically) to pay a processing fee to the service provider hosting the gift card platform or exchange service. At step 318, the processing fee actually paid by the consumer is transferred to the web-based platform provider (e.g. to the web-based provider's electronic check deposit (ECD) account). The payment may be made from a credit card, PayPal or other suitable payment method.

At step 314, an electronic notification is sent to the merchant that an electronic gift car (i.e. “gift card” or “ecard”) has been purchased. The amount is automatically approved and the process moves to 322, unless the purchase amount exceeds the limit the merchant has put on the live offer page, in which case the merchant approves the transfer of funds at 320, funds are transferred from the merchant's marketing account to the merchant gift card account. At 322, the service provider receives information indicating merchant approval of the transfer and funds are transferred. At 316, the proceeds from the purchase are instantly transferred to the merchant or merchant services account and to the web-based platform provider's account. At 324, the merchant receives the funds from the gift card sales, with the transaction fee subtracted. At 326, a transaction fee is transferred to the web-based platform provider's account. The transaction fee may be a percentage of what the consumer pays for the card, for example. This amount may be transferred to the service provider's, e.g., eCardDeal.com, bank account. Thus, as shown in process 300, the web-based platform distributes the applicable proceeds to the respective parties upon the consumer's purchase of the gift card while interfacing with the associated point of sale systems for proper redemption.

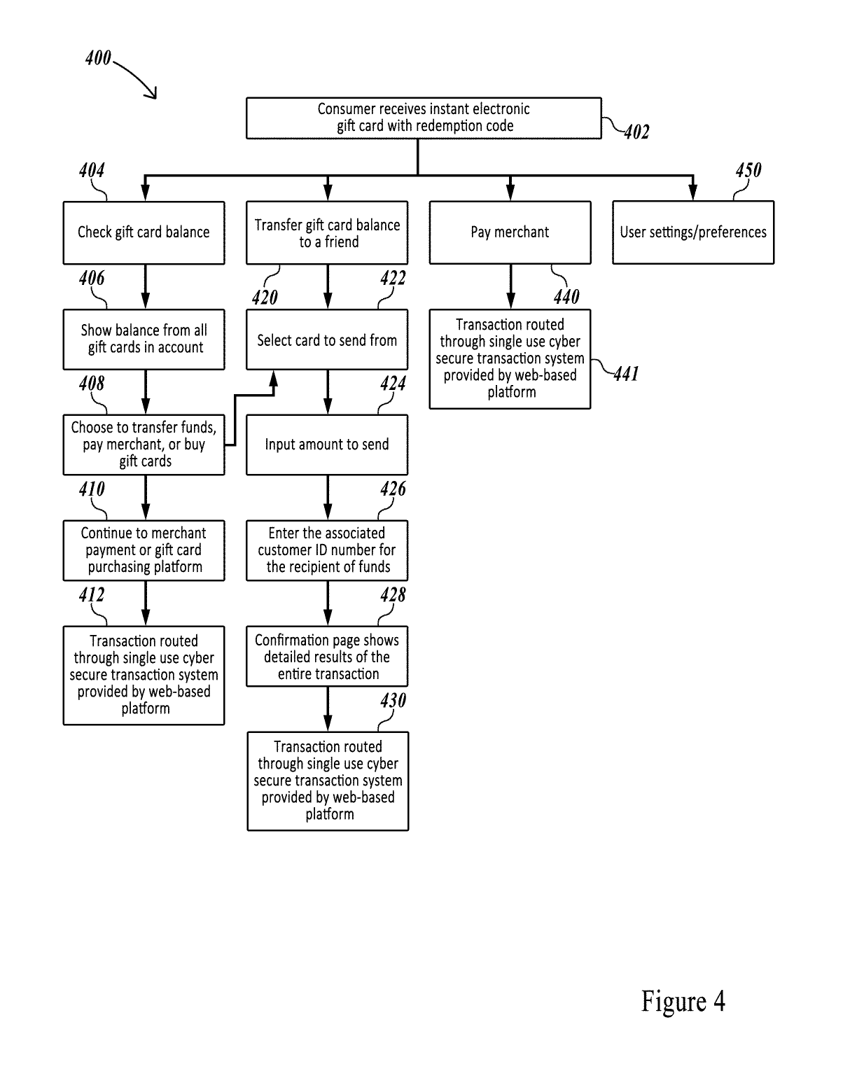

FIG. 4 illustrates an example process relating to interaction with a user interface for a consumer conducting transactions relating to a gift card. At step 402, the customer has received the instant electronic gift card with a unique identifier stored on the customer's mobile device. At step 404, the customer may check the available balance associated with a selected ecard in the customer's virtual wallet. At step 406, the balance of all ecards purchased by the customer and in the customer's wallet may be displayed. At step 408, the user may be presented with button options for TRANSFER FUNDS, PAY MERCHANT or BUY CARDS. If PAY MERCHANT is selected, at step 410 the user is taken to a platform where the merchant transaction may be consummated. After the transaction with the merchant occurs, the transaction is routed through the proprietary platform of the service provider at step 412. The transaction may be facilitated by a cyber secure single use transaction, as will be explained below.

At step 420, the user may select a function to transfer his or her ecard balance to a friend. If such option is selected, at step 422 a desired card from which to transfer funds balance is selected. At step 424, an amount to send is input. At step 426, the user may specify a customer ID or other information identifying the person desired to receive the transferred funds balance. At step 428, a confirmation page may be displayed to confirm the recipient, amount sent and ecard affected. At step 430, the transaction is routed through the proprietary platform of the service provider. At step 440, the merchant is paid with the gift card. At step 441, the payment transaction is routed through the proprietary platform to effect payments to the appropriate parties. At step 450, a user can set and manage account preferences and setting.

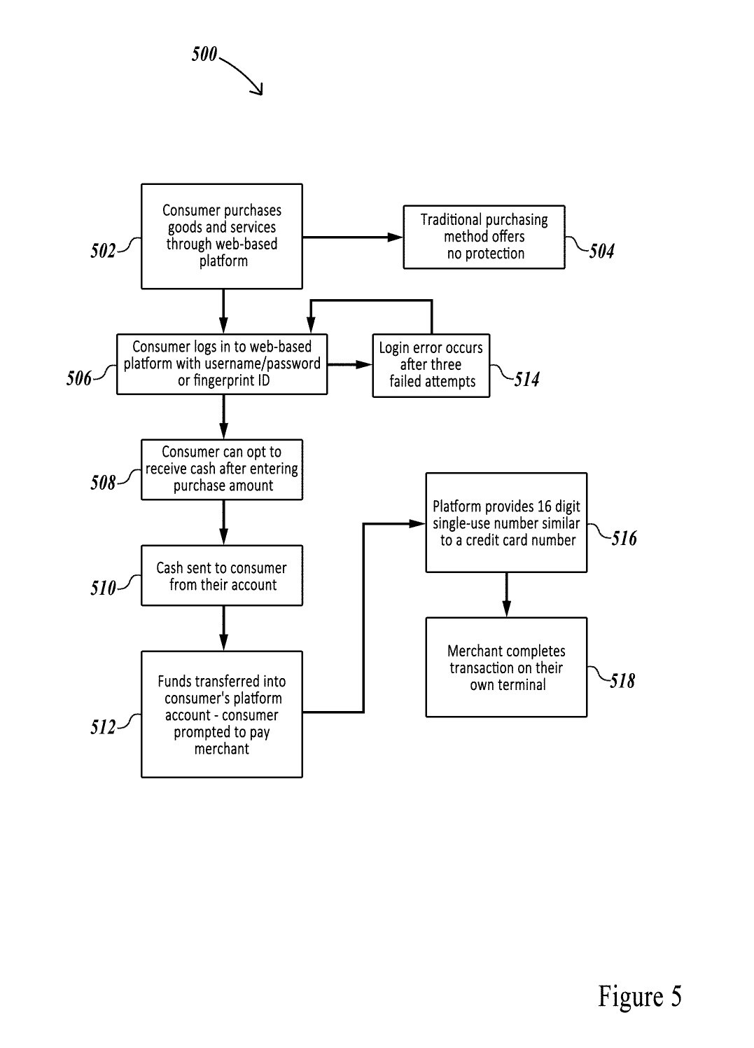

FIG. 5 represents a cyber secure single use transaction process. In this process, a single use identifier, which has a limited predetermined lifetime, is used to effect a secure transaction. At step 501, a consumer may utilize an ecard to purchase goods and/or services. Alternatively, at step 504, conventional purchasing may be used without the security measures provided by the single use transaction. At step 506, the user logs into the web-based platform provider's account using a username and password combination, or biometric information such as a fingerprint. At step 514 three errors may be permitted before the user is locked out. At step 508, the user may select a RECEIVE CASH button via a mobile application and then enter an amount of the purchase. At step 510, the system may send cash to the consumer from their account (only the last four digits of the ID number may be displayed). At step 512, once money is transferred to the user's account, the consumer is prompted to press a PAY MERCHANT button to finalize payment to the merchant. In response, at step 516, the device receives a unique 16-digit identifier that may be displayed on the phone or otherwise conveyed to the merchant. At step 518, the merchant inputs the code into their point of sale payment system and it has the effect of cash.

The EcardDeal.com single use process may be an encrypted service wherein the merchant receives cash from the consumer via a bank or credit card, but through an eCardDeal.com single use “filter.” The credit card number or transaction number is only good for one use and is forever retired. The transaction combinations are limitless and the merchant never knows from what bank or account the money has been received (much like if a person physically went to the ATM or received a cash advance while waiting to pay a merchant). The relationship is strictly between the bank and the merchant. The eCardDeal process enables the consumer to essentially pay with cash. Like cash, once the consumer makes the payment they no longer have funds in their eCardDeal wallet.

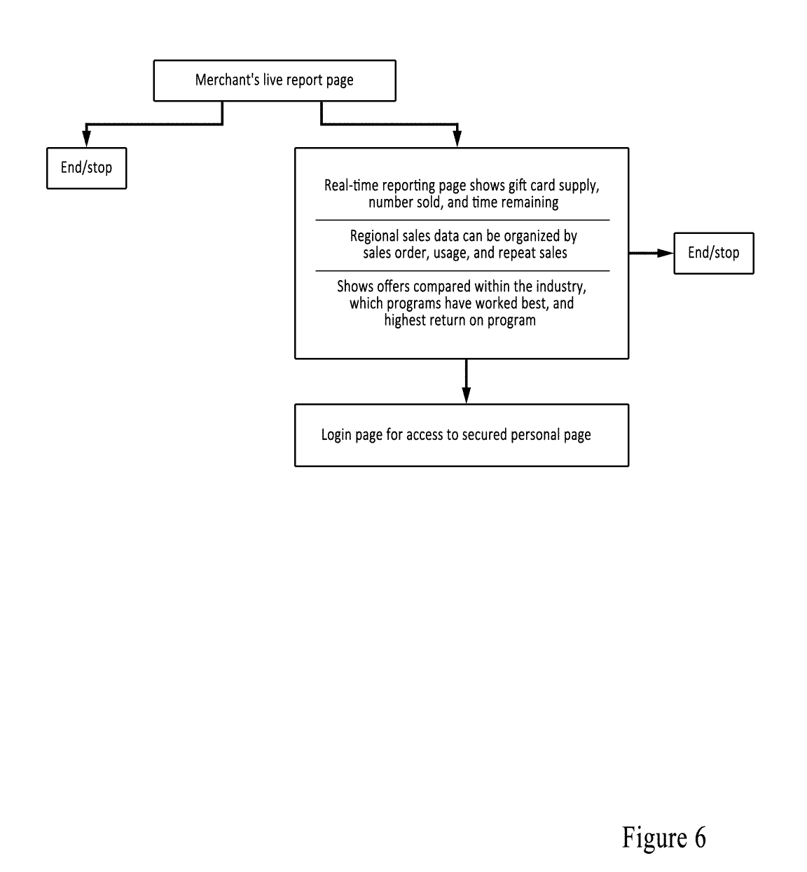

FIG. 6 illustrates a reporting capability process 600 for a merchant. The reporting component of an application may provide for real time reporting to a merchant to show the remaining gift card supply (i.e. remaining inventory), the number or value of cards sold, and the time remaining for a program. Data may be organized by geographic categories and may provide industry benchmarking data that is relevant to the gift card programs being supported for the particular merchant. Analytic tools may provide indications of which previous gift card programs were most effective, which generated the highest return, or other criteria.

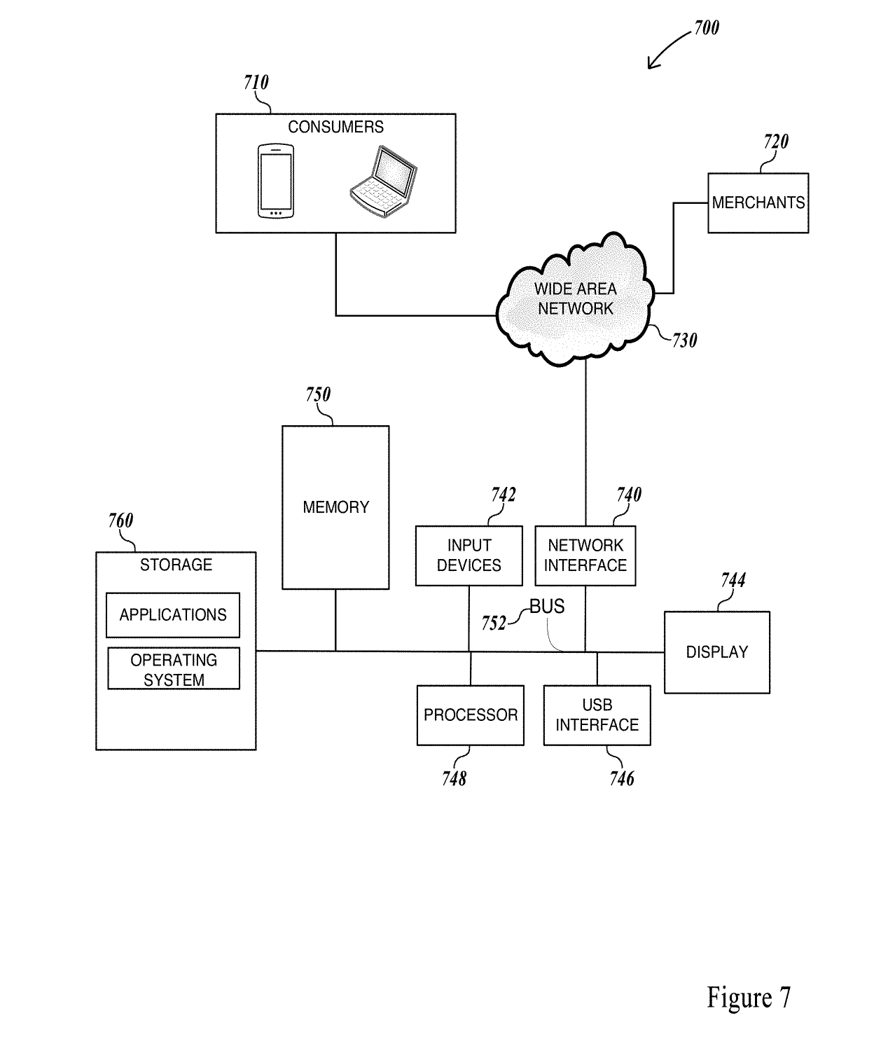

FIG. 7 is an exemplary computing technology platform 700 suitable for implementing aspects of the invention. A processor 748 and memory 750, which may include ROM and RAM, communicate through a data bus 752. Input devices 742 and output devices, e.g. display 744, and USB interface 746, also communicate with the bus 752. A storage device 760, which may include a disk drive, stores instructions and data (including databases) for the processor 748 and may be in the form of applications and one or more operating systems. A network interface 740 may provide for communication of the platform with a wide area network (WAN) 730 such as the Internet. The WAN 730 provides for electronic communication of data between consumers 710 and merchants 720 via mobile devices, desktop devices or other remote computing platforms.

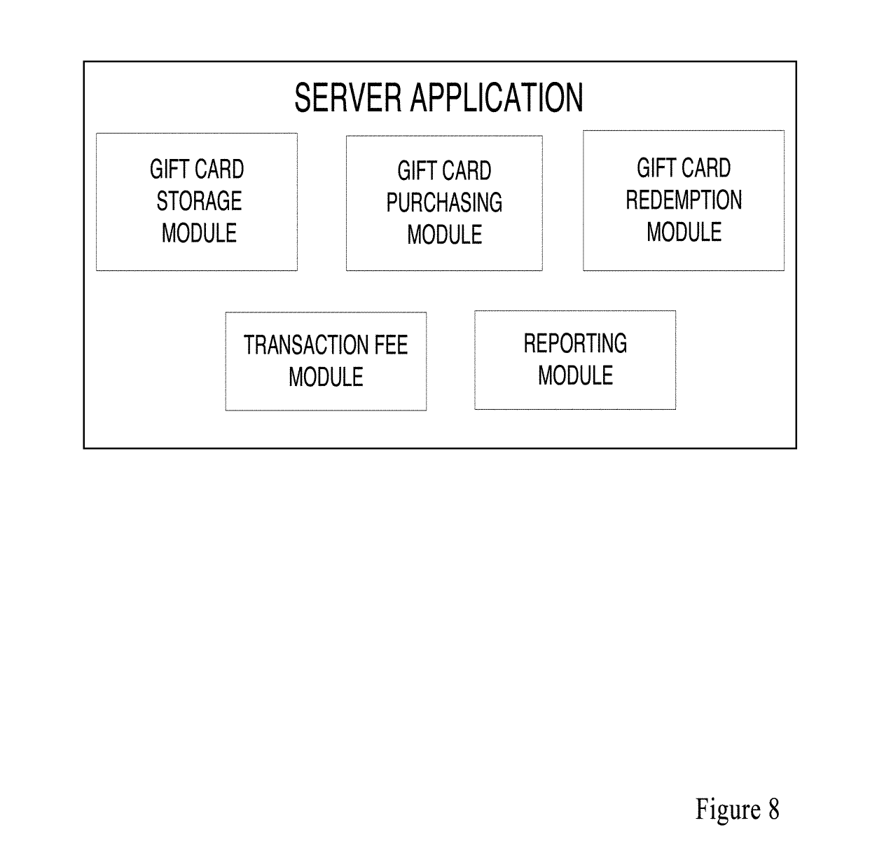

FIG. 8 is a schematic diagram illustrating an exemplary software architecture 800 for a server application supporting the processes described above, including a gift card storage module 810, gift card purchasing module 820, gift card redemption module 830, transaction fee module 840, and reporting module 850.

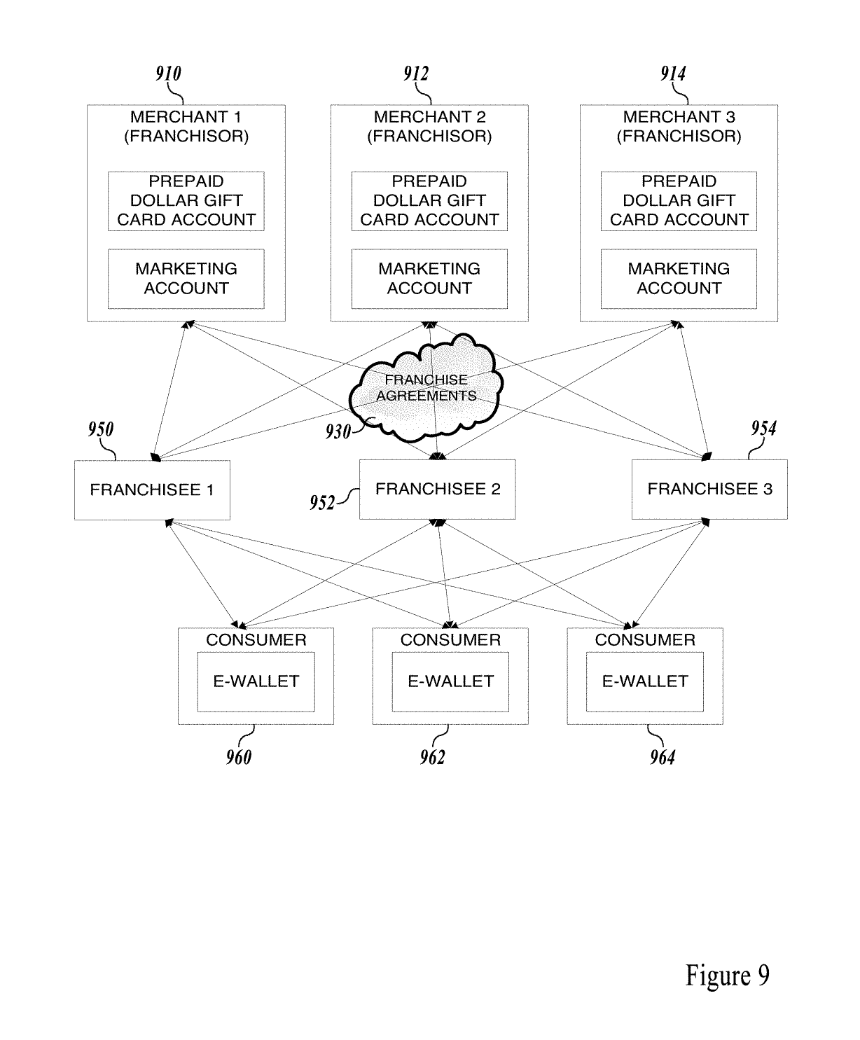

FIG. 9 illustrates the information exchange between merchants (910, 912, and 914), franchisees (950, 952, and 954) operating under franchise agreements 930, and consumers (960, 962, and 964).

While there have been described herein what are considered to be preferred and exemplary embodiments of the present invention, other modifications of the invention shall be apparent to those skilled in the art from the teachings herein. It is therefore desired to be secured, in the appended claims all such modifications as fall within the spirit and scope of the invention.

What is claimed is:

1. A web-based platform for creating of gift card programs comprising:
a database configured to receive and store user account information that can be accessed by the user through one or more user interfaces upon logging into the web-based platform;
wherein the database is further configured to receive and store gift card program parameters that can be accessed by the user through one or more user interfaces, the gift card program parameters including the available gift card denominations, the program start and end dates, the amount of funds committed to the program, and the gift card discount percentage;
a user interface for creating the user account, wherein the user interface is in communication with the database;
a user interface for designating the available gift card denominations, wherein the user interface is in communication with the database;
a user interface for designating the gift card program start and end dates, wherein the user interface is in communication with the database;
a user interface for designating the amount of funds committed to the program, wherein the user interface is in communication with the database;
a user interface for designating the gift card discount percentage, wherein the user interface is in communication with the database;
a user interface for designating a category for the products or services associated with the gift card program, wherein the user interface is in communication with the database; and
a user interface for confirming and publishing the designated gift card program parameters, wherein the user interface is in communication with the database.

2. The web-based platform of claim 1 further comprising a user interface for displaying user account information associated with the user account, the user account information including the user name, location, contact information, and links to past and present gift card programs.

3. The web-based platform of claim 1 further comprising a user interface for modifying an existing gift card program.

4. A computer implemented method for creation of gift card program through a web-based platform comprising:
providing access to a registered user account database that stores user account information;
creating a user account, wherein the user interface is in communication with the database;
submitting available gift card denominations;
submitting gift card program start and end dates;
submitting the amount of funds committed to the program;
submitting the percent discount for the gift card discount percentage;
submitting a category designation for the products or services associated with the gift card program;
presenting the designated gift card program parameters for user confirmation; and
publishing the gift card program.

5. The computer implemented method of claim 4 further comprising receiving modifications to an existing gift card program.

6. The computer implemented method of claim 4 the user account information comprises displaying the remaining gift card inventory in the gift card program, displaying the number of gift cards sold in the gift card program, displaying the value of gift cards sold in the gift card program, and displaying the time remaining in the gift card program.

7. A computer implemented method for managing a gift card program through a web-based platform comprising:
selecting a merchant offering electronic gift cards;
selecting an electronic gift card from among one or more electronic gift cards offered by said merchant;
purchasing an electronic gift card, the price of the gift card comprising an electronic gift card cost and a processing fee;
generating an electronic gift card having a redemption code;
notifying the merchant and a merchant services provider that an electronic gift card has been purchased;
transferring the proceeds from the electronic gift card purchase, minus a transaction fee, to a financial account of the merchant; and
transferring the transaction fee to a financial account of a provider of the web-based platform.
